(19) United States
(12) Patent Application Publication
(10) Pub. No.: US 2021/0063765 A1
(43) Pub. Date: Mar. 4, 2021

(54) WAVEGUIDE-BASED AUGMENTED REALITY DISPLAY APPARATUS

(71) Applicant: AAC Optics Solutions Pte. Ltd., Singapore City (SG)

(72) Inventor: Meng Yang, Shenzhen (CN)

(21) Appl. No.: 17/035,787

(22) Filed: Sep. 29, 2020

Related U.S. Application Data
(63) Continuation of application No. PCT/CN2019/104519, filed on Sep. 5, 2019.

(30) Foreign Application Priority Data
Aug. 28, 2019 (CN) 201910804476.3

(51) Int. Cl. G02B 30/26; G02B 27/01; G02F 1/01; G02B 27/30

(52) U.S. Cl. CPC G02B 30/26; G02B 27/30; G02F 1/0136; G02B 27/0101

(57) ABSTRACT

The present disclosure relates to a waveguide-based augmented reality display apparatus, which includes an image source alternately displaying an image at a preset frequency and correspondingly generates a first polarized light and a second polarized light; a single waveguide being spaced from the image source; a first in-coupling device, arranged on one side of the waveguide and configured to couple the first polarized light into the waveguide; a second in-coupling device, arranged on the other side of the waveguide and configured to couple the second polarized light into the waveguide; an out-coupling device, arranged on the waveguide and configured to alternately couple out a first sub-image and a second sub-image in a preset area. The first and second sub-images are alternately displayed, and are fused and superimposed in human eyes due to a persistence of vision, thereby increasing a field of view and an image resolution.

### TECHNICAL FIELD

The present disclosure relates to the optical technology, in particular to a waveguide-based augmented reality display apparatus.

### BACKGROUND

Augmented reality (or mixed reality) display technology may superimpose virtual images into the real world to achieve the purpose of fusing virtual information with the real world. Augmented reality display technology can enhance information expressed in the real world, so it has broad application prospects in education, remote cooperation, traffic navigation and other fields. The waveguide-based augmented reality display apparatus has the advantages of compact structure, small size and easy for the exit pupil to expand, and has been used in products by Microsoft, Sony, Magicleap and other companies.

Due to the limitation of total reflection condition of waveguide, the field of view of the waveguide-based augmented reality display apparatus is generally small. The traditional waveguide augmented reality display apparatus is usually provided with two waveguides in order to increase the field of view, wherein, one waveguide is used to transmit a light beam generated by an image source according to image data of a left half of a displayed image, and the other waveguide is used to transmit a light beam generated by the image source according to image data of a right half of the displayed image, so as to increase the field of view. However, the dual-waveguide configuration will increase the thickness and weight of the waveguide display apparatus, which will greatly reduce user experience of the waveguide display apparatus.

### SUMMARY

Therefore, it is necessary to provide a waveguide display apparatus which can increase a field of view and has a compact structure.

The present disclosure provides a waveguide-based augmented reality display apparatus, which includes:

an image source, configured to display an image and generate a light beam according to image data of the displayed image, wherein the light beam includes a first polarized light and a second polarized light alternately displayed at a preset frequency, the first polarized light has a first polarization state and the second polarized light has a second polarization state different from the first polarization state;

a single waveguide, being spaced from the image source;

a first in-coupling device, arranged on one side of the waveguide adjacent to the image source, and configured to couple the first polarized light into the waveguide;

a second in-coupling device, arranged on one side of the waveguide away from the first in-coupling device, and configured to couple the second polarized light into the waveguide;

a first out-coupling device, arranged on one side of the waveguide adjacent to the image source, and configured to couple out a first sub-image of the first polarized light propagating in the waveguide in a preset area; and

a second out-coupling device, arranged on one side of the waveguide away from the first out-coupling device, and configured to couple out a second sub-image of the second polarized light propagating in the waveguide in the same preset area;

wherein, an out-coupling grating vector of the first polarized light and a out-coupling grating vector of the second polarized light have different directions, and the first sub-image and the second sub-image are alternately displayed, and are fused and superimposed in human eyes due to a persistence of vision.

In one embodiment, the first in-coupling device and the first out-coupling device are transmission gratings, and the second in-coupling device and the second out-coupling device are reflection gratings;

the second polarized light is coupled into the waveguide through the second in-coupling device, totally reflected in the waveguide and transmitted to the second out-coupling device, and then coupled out to the preset area through the second out-coupling device and the first out-coupling device sequentially.

In one embodiment, the first polarization state and the second polarization state are an S polarization state and a P polarization state, respectively.

In one embodiment, the first polarization state and the second polarization state are a left-handed circular polarization state and a right-handed circular polarization state, respectively.

In one embodiment, the image source includes an image display for displaying the image and a polarization modulator arranged on one side of the image display adjacent to the waveguide. The polarization modulator is configured to generate the first polarized light and the second polarized light displayed alternately based on the image data of the image.

In one embodiment, the first in-coupling device and the second in-coupling device are arranged on opposite sides of the waveguide and are aligned coaxially with an optical axis.

In one embodiment, the first out-coupling device and the second out-coupling device are arranged on opposite sides of the waveguide and are aligned coaxially with an optical axis.

In one embodiment, the image source is configured to alternately form the first polarized light and the second polarized light at a frequency greater than or equal to 48 frames per second, so that the display frequencies of the coupled-out first sub-image and the second sub-image are greater than or equal to 24 frames per second, respectively.

In one embodiment, the waveguide-based augmented reality display apparatus further includes a collimator arranged between the image source and the waveguide. The collimator is configured to process the first polarized light and the second polarized light into a collimated light.

In one embodiment, the first out-coupling device and the second out-coupling device have a grating vector of

$$\frac{\sqrt{2}}{2} {k}_{0} \sqrt{{n}_{1}^{2} + 1} ,$$

, wherein k₀=2π/λₓ, and x=1 or 2; wherein λ₁ represents a wavelength of the first polarized light, and λ₂ represents a wavelength of the second polarized light, n₁ represents a refractive index of the waveguide; an out-coupling grating of the first out-coupling device and an out-coupling grating of the second out-coupling device have an angle of φ with a respective corresponding in-coupling grating, wherein φ=π/2-θ,

$$0 < θ \leq arcsin ( \frac{{n}_{1} - 1}{\sqrt{2} \sqrt{{n}_{1}^{2} + 1}} ) .$$

The present disclosure provides a waveguide-based augmented reality display apparatus, which can realize the expansion of the field of view only by setting a single waveguide. Moreover, the image source alternately displays the images of the left and right fields of view to achieve the purpose of improving the resolution of the displayed image. In the above waveguide display apparatus, the light beams generated by the image source include the first polarized light and the second polarized light alternately displayed at the preset frequency. The first polarized light has the first polarization state, and the second polarized light has the second polarization state different from the first polarization state. Since the first in-coupling device and the second in-coupling device located on both sides of the single waveguide have a polarization selectivity, the first in-coupling device located on the side of the waveguide adjacent to the image source may only diffract the first polarized light, but not the second polarized light, while the second in-coupling device located on the side of the waveguide away from the first in-coupling device may only diffract the second polarized light, but not the first polarized light. Therefore, the first polarized light and the second polarized light alternately generated by the image source at the preset frequency may be coupled into the waveguide by the first in-coupling device and the second in-coupling device respectively, and then the first sub-image and the second sub-image are coupled out of the first polarized light and the second polarized light propagating in the waveguide in the same preset area by the out-coupling device respectively. Since the coupled-out first sub-image and the second sub-image are alternately displayed in human eyes, based on the persistence of human vision, the human eyes will automatically fuse and superimpose the first sub-image and the second sub-image into a total image. Therefore, the above waveguide display apparatus can realize the superposition and doubling of two different fields of view through the single waveguide. Compared with the traditional waveguide display apparatus with dual-waveguide, the thickness and weight of the waveguide display apparatus are reduced. At the same time, because the first sub-image and the second sub-image have corresponding resolutions, the resolution of the fused total image is equal to the superposition of the resolutions of the first sub-image and the second sub-image. Therefore, the present solution can significantly increase the field of view and the resolution of the image on the premise of ensuring a compact structure of the waveguide display apparatus, and greatly improve the user experience.

### BRIEF DESCRIPTION OF THE DRAWINGS

FIG. 1 is a schematic diagram of a principle of a traditional waveguide-based augmented reality display apparatus;

FIG. 2 is a schematic diagram of an optical path at a first time point of a waveguide-based augmented reality display apparatus in an embodiment of the present disclosure;

FIG. 3 is a schematic diagram of an optical path at a second time point adjacent to the first time point of a waveguide-based augmented reality display apparatus in an embodiment of the present disclosure; and

FIG. 4 is a schematic diagram of a grating vector in which a first polarized light and a second polarized light are respectively coupled into, deflected and coupled out of a waveguide in an embodiment of the present disclosure.

FIG. 5 is a schematic diagram of an optical path of a light beam that is coupled out of an out-coupling grating of an upper surface of the waveguide.

### DETAILED DESCRIPTION

The present disclosure will be further illustrated with reference to the accompanying drawings and embodiments.

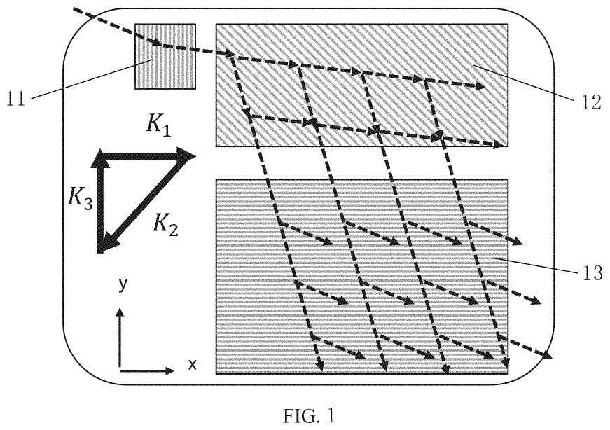

As shown in FIG. 1, a traditional waveguide display apparatus includes a waveguide, and an in-coupling device 11, a deflector 12 and an out-coupling device 13 mounted on the waveguide. The in-coupling device 11 is configured to couple a light beam into the waveguide. After passing through the waveguide, the light beam is deflected by the deflector 12 to change a transmission direction of the light beam in the waveguide 12, so as to realize an expansion of the light beam in an X direction. The out-coupling device 13 is configured to couple out the light beam propagating in the waveguide while realizing an exit pupil expansion of the light beam in a Y direction. The in-coupling device 11, the deflector 12 and the out-coupling device 13 may be holographic optical elements (HOE) or diffractive optical elements, including a volume holographic grating, a tilted grating and a blazed grating.

Specifically, for convenience of description, the corresponding grating vectors of the light beams in the in-coupling device 11, the deflector 12 and the out-coupling device 13 are respectively denoted as K₁, K₂and K₃, and the corresponding propagation periods of the light beams in the in-coupling device 11, the waveguide 12 and the out-coupling device 13 are respectively denoted as Λ₁, Λ₂ and Λ₃. The direction of the grating vector is parallel to a corresponding grating period direction;

A magnitude of K₁: |K₁|=2π/Λ₁;

A magnitude of K₂: |K₂|=2π/Λ₂; and

A magnitude of K₃: |K₃|=2π/Λ₃.

As shown in FIG. 1, the corresponding grating vectors K₁, K₂ and K₃ of the light beams in the in-coupling device 11, the waveguide 12 and the out-coupling device 13 form a closed triangle, that is, K₁+K₂+K₃=0. At this time, a propagation direction of the light beam coupled into the waveguide 12 is the same as that of the light beam coupled out of the waveguide 12.

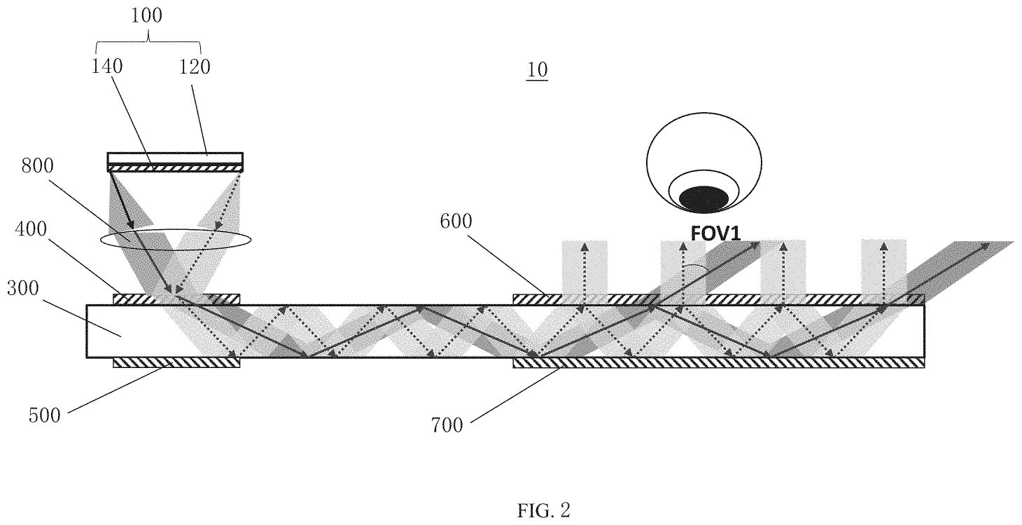

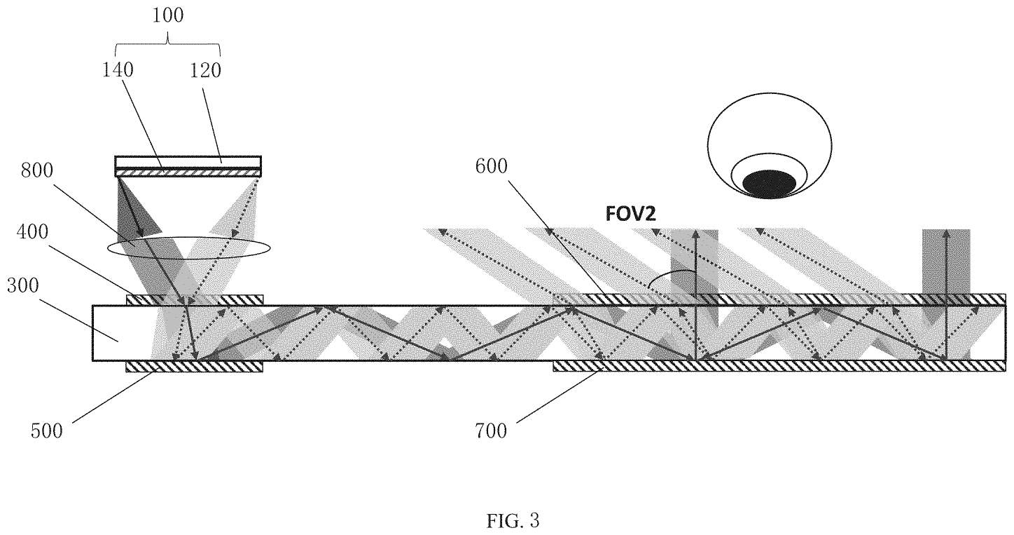

As shown in FIG. 2 and FIG. 3, a waveguide-based augmented reality display apparatus 10 in an embodiment of the present disclosure includes an image source 100, a waveguide 300, a first in-coupling device 400, a second in-coupling device 500 and an out-coupling device. In order to be more intuitive, the waveguide display apparatus 10 in this embodiment does not have a deflector, but this does not affect a core idea of the present disclosure. In other embodiments of the present disclosure, a deflector may be set on a surface of the waveguide 300, to change a propagation of a light beam within the waveguide 300. In this embodiment, the out-coupling device includes a first out-coupling device 600 and a second out-coupling device 700 located on opposite sides of the waveguide 300. The image source 100 is configured to display an image and generate a light beam according to image data of the displayed image. The light beam includes a first polarized light and a second polarized light alternately displayed at a preset frequency. The first polarized light has a first polarization state, and the second polarized light has a second polarization state different from the first polarization state.

The waveguide 300 is spaced from the image source 100, and there is one waveguide 300. The first in-coupling device 400 is arranged on one side of the waveguide 300 adjacent to the image source 100, and the first in-coupling device 400 is configured to couple the first polarized light into the waveguide 300. The second in-coupling device 500 is arranged on one side of the waveguide 300 away from the first in-coupling device 400, and the second in-coupling device 500 is configured to couple the second polarized light into the waveguide 300. The first out-coupling device 600 is arranged on the waveguide 300, and the first out-coupling device 600 is configured to couple out a first sub-image of the first polarized light propagating in the waveguide 300 in a preset area. The second out-coupling device 700 is arranged on one side of the waveguide 300 away from the first out-coupling device 600, and the second out-coupling device 700 is configured to couple out a second sub-image of the second polarized light propagating in the waveguide 300 in the same preset area. The first sub-image and the second sub-image are alternately displayed in human eyes, and are fused and superimposed due to a persistence of vision.

As shown in FIG. 2, at a first time point, the image source 100 displays the image and generates the corresponding first polarized light according to the image data. Since the first in-coupling device 400 and the second in-coupling device 500 respectively located on two sides of the single waveguide 300 have a polarization selectivity, i.e., the first in-coupling device 400 located on the side of the waveguide 300 adjacent to the image source 100 may only diffract the first polarized light, but not the second polarized light, while the second in-coupling device 500 located on the side of the waveguide 300 away from the first in-coupling device 400 may only diffract the second polarized light, but not the first polarized light. Correspondingly, the first out-coupling device 600 and the second out-coupling device 700 also have the polarization selectivity. The first out-coupling device 600 may only diffract the first polarized light, while the second out-coupling device 700 may only diffract the second polarized light. Therefore, the first polarized light generated by the current image source 100 may only be coupled into the waveguide 300 by the first in-coupling device 400, and then propagates forward in a shape of a total internal reflection in the waveguide 300. After reaching the preset area, the first polarized light is coupled out of the waveguide 300 by the first out-coupling device, forming the first sub-image in human eyes. Preferably, both the first in-coupling device 400 and the first out-coupling device 600 are transmission gratings.

As shown in FIG. 3, at an adjacent second time point, the image source 100 generates the second polarized light. Accordingly, the second polarized light generated by the current image source 100 may only be coupled into the waveguide 300 by the second in-coupling device 500. Then the second out-coupling device 700 couples out the second sub-image of the second polarized light propagating in the waveguide 300 in the same preset area. Specifically, the second polarized light is coupled into the waveguide 300 through the second in-coupling device 500, totally reflected within the waveguide 300 and transmitted to the second out-coupling device 700, and is coupled out to the preset area through the second out-coupling device 700 and the first out-coupling device 600 in turn. Preferably, the second in-coupling device 500 and the second out-coupling device 700 are reflection gratings. Since the first sub-image coupled out at the first time point and the second sub-image coupled out at the second time point are alternately displayed, based on the persistence of human vision in human eyes, the human eyes will automatically fuse and superimpose the first sub-image and the second sub-image into a total image. Therefore, the above waveguide display apparatus 10 realizes a superposition and doubling of two different fields of view through the single waveguide 300. Compared with the traditional waveguide display apparatus with dual-waveguide, a thickness and weight of the waveguide display apparatus 10 are reduced. Moreover, because the first sub-image and the second sub-image displayed at different time points have corresponding resolutions, the resolution of the fused total image is equal to the superposition of the resolutions of the first sub-image and the second sub-image. Therefore, the present solution can significantly increase the field of view and the resolution of the image on the premise of ensuring a compact structure of the waveguide display apparatus 10, and greatly improve the user experience.

Preferably, the image source 100 alternately forms the first polarized light and the second polarized light at a frequency greater than or equal to 48 frames per second, so that the display frequencies of the coupled-out first sub-image and the coupled-out second sub-image are greater than or equal to 24 frames per second, respectively, thereby ensuring that the picture finally seen by human eyes is continuous.

Further, the first in-coupling device 400 and the second in-coupling device 500 are arranged on opposite sides of the waveguide 300 and are aligned coaxially with an optical axis. Specifically, the first in-coupling device 400 and the second in-coupling device 500 are arranged on the two opposite sides of the waveguide 300 in a thickness direction and are in aligned coaxially with the optical axis.

In an embodiment, the first polarization state and the second polarization state are an S polarization state and a P polarization state, respectively. It can be understand that in other embodiments, the first polarization state and the second polarization state are a left-handed circular polarization state and a right-handed circular polarization state, respectively.

As shown in FIG. 2 and FIG. 3, further, in this embodiment, the first out-coupling device 600 and the second out-coupling device 700 are arranged on opposite sides of the waveguide 300 and are aligned coaxially with the optical axis. Specifically, the first out-coupling device 600 and the second out-coupling device 700 are arranged on the two opposite sides of the waveguide 300 in the thickness direction and are in aligned coaxially with the optical axis.

As shown in FIG. 2, in an embodiment, an image source 100 includes an image display 120 for displaying the image and a polarization modulator 140 arranged on one side of the image display 120 adjacent to the waveguide 300. The polarization modulator 140 is configured to, based on the image data of the image, generate the first polarized light and the second polarized light alternately displayed. Specifically, the image display 120 may be a micro organic light emitting diode (Micro OLED), a liquid crystal on silicon (LCoS), a digital light processor (DLP), and a microelectromechanical laser scanning display (MEMS Laser Scanning Display). A micro display alternately displays the first sub-image of a left field of view and the second sub-image of a right field of view at a preset frequency. A fast polarization modulator converts the light beam generating the first sub-image into the first polarized light with the first polarization state and the light beam generating the second sub-image into the second polarized light with the second polarization state at the same frequency.

In an embodiment, the above waveguide display apparatus 10 further includes a controller. The controller is electrically connected with the image display 120 and the polarization modulator 140. The controller is configured to control an operation of the image display 120 and the polarization modulator 140.

As shown in FIG. 2 and FIG. 3, in an embodiment, the above waveguide display apparatus 10 further includes a collimator 800 arranged between the image source 100 and the waveguide 300. The collimator 800 is configured to process the first polarized light and the second polarized light into a collimated light. Specifically, in this embodiment, the collimator 800 is arranged between the polarization modulator 140 and the waveguide 300.

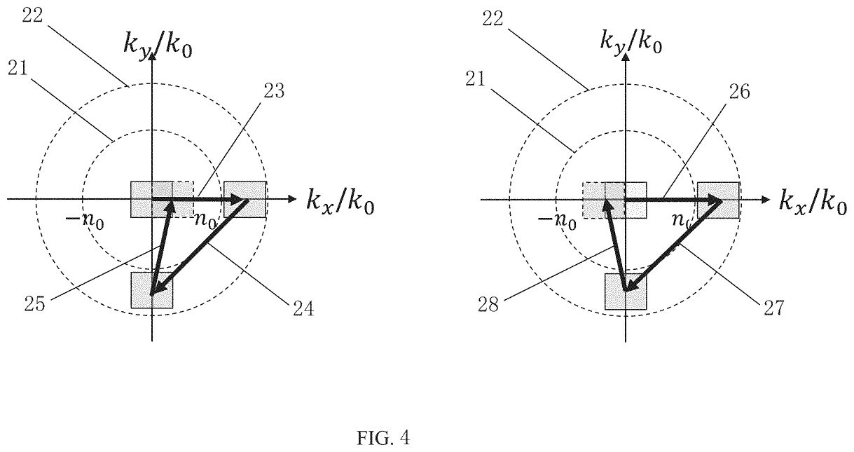

As shown in FIG. 4, for the waveguide display apparatus 10 in this embodiment, a refractive index of air is defined as n₀, and a refractive index of the waveguide 300 is defined as n₁. An inner imaginary circle 21 in a wave vector space diagram is a boundary of the total internal reflection (TIR) of the light beams in the waveguide 300. A rectangular frame represents a distribution range of the light beams displaying the image in the wave vector space. In this embodiment, the light beams include the first polarized light and the second polarized light which are alternately displayed at the preset frequency. The condition for the total internal reflection of the light beam within the waveguide 300 is: kₓ²+k_{y}²>k₀², so a radius of the inner imaginary circle 21 is n₀. An outer imaginary circle 22 is a boundary of an exit pupil continuity of the light beam, and a radius of the outer imaginary circle 22 is less than n₁. Therefore, the light beam whose grating vector is larger than the radius of the outer imaginary circle cannot satisfy the exit pupil continuity condition. A grating vector provided by the in-coupling grating may move the light beam (rectangle) of the image in the air from a center of the wave vector space to a space between the radius of the inner imaginary circle 21 and the outer imaginary circle 22, indicating that the light beam of the image may be completely coupled into the waveguide 300. The incident light in air has a refractive index n₀=1, and a largest FOV for coupling in the waveguide is k₀(n₁−1); in the wave vector space, k₀=2 π/λₓ, and x=1 or 2, λ₁ represents a wavelength of the first polarized light, and λ₂ represents a wavelength of the second polarized light. The corresponding in-coupling grating period is A₁=2λ/(n₁+1). The out-coupling grating has a same grating vector with the in-coupling grating, and thus A₃=A₁.

Specifically, the grating vectors corresponding to the first polarized light in the first in-coupling device 400, the deflector and the first out-coupling device 600 are respectively a first solid line with arrow 23, a second solid line with arrow 24 and a third solid line with arrow 25 shown in FIG. 4. The grating vectors corresponding to the second polarized light in the second in-coupling device 500, the deflector and the second out-coupling device 700 are respectively a fourth solid line with arrow 26, a fifth solid line with arrow 27 and a sixth solid line with arrow 28 shown in FIG. 4. As shown in FIG. 2 and FIG. 3, the propagation direction of the coupled-out light beam is deflected at a certain angle relative to the propagation direction of the coupled-in light beam, thereby forming an image of the left field of view in human eyes; The propagation direction of the coupled-out light beam is deflected at a certain angle relative to the propagation direction of the coupled-in light beam, thereby forming an image of the right field of view in human eyes. Therefore, in the present solution, a sum of the corresponding grating vectors of the first polarized light in the first in-coupling device 400, the deflector, and the first out-coupling device 600, and a sum of the corresponding grating vectors of the second polarized light in the second in-coupling device 500, the deflector and second out-coupling device 700 are no longer zero, so that the propagation direction of the light beam coupled out of the waveguide 300 is deflected relative to the propagation direction of the light beam coupled into the waveguide 300. The directions of the coupled-out grating vectors of the two polarized lights are different, thus coupling out through their corresponding out-coupling devices. In this case, the grating vector of the out-coupling grating is

$$\frac{\sqrt{2}}{2} {k}_{0} \sqrt{{n}_{1}^{2} + 1} ,$$

, and a corresponding grating period is

$${Λ}_{3} = \frac{2 λ}{\sqrt{2} \sqrt{{n}_{1}^{2} + 1}} ,$$

, which is larger than A₁. The deflection angle of the grating direction is

$$0 < θ \leq arcsin ( \frac{{n}_{1} - 1}{\sqrt{2} \sqrt{{n}_{1}^{2} + 1}} ) .$$

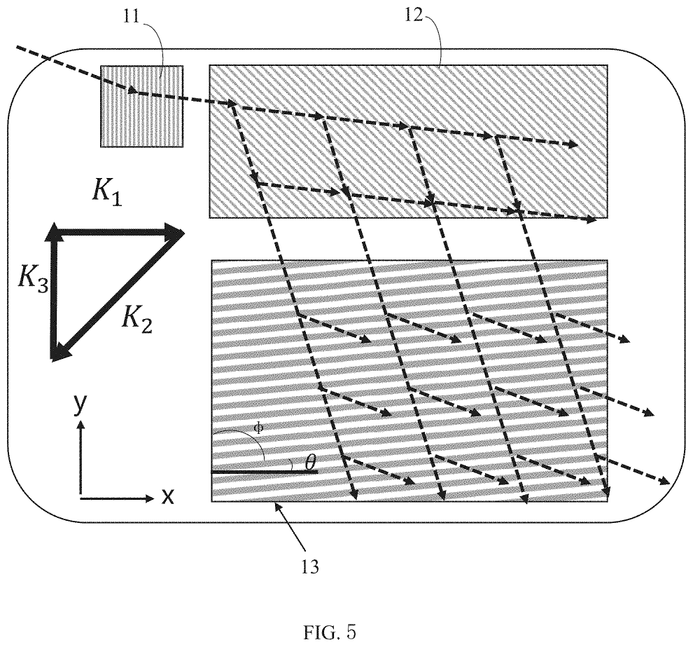

As shown in FIG. 4, the out-coupling grating of the first out-coupling device and the out-coupling grating of the second out-coupling device have an angle of φ with the respective corresponding in-coupling grating, and φ=π/2-θ. The two out-coupling gratings have different deflection directions, one is deflected clockwise by θ, and the other is deflected counterclockwise by θ. FIG. 5 shows an optical path out-coupled by one of the out-coupling gratings after deflection, and in FIG. 5, the grating direction of the out-coupling grating is rotated clockwise by θ.

Since the sum of the corresponding grating vectors of the first polarized light in the first in-coupling device 400, the deflector, and the first out-coupling device 600, and the sum of the corresponding grating vectors of the second polarized light in the second in-coupling device 500, the deflector and second out-coupling device 700 are not zero, the coupled-out first sub-image and/or the second sub-image may be dispersed, which is not conducive to a color display of the final image. In the present solution, the first sub-image and the second sub-image may be displayed by the MEMS laser scanning display with a narrow wavelength bandwidth.

In the above waveguide display apparatus 10, the light beams generated by the image source 100 include the first polarized light and the second polarized light alternately displayed at the preset frequency. The first polarized light has the first polarization state, and the second polarized light has the second polarization state different from the first polarization state. Since the first in-coupling device 400 and the second in-coupling device 500 located on both sides of the single waveguide 300 have a polarization selectivity, the first in-coupling device 400 located on the side of the waveguide 300 adjacent to the image source 100 may only diffract the first polarized light, but not the second polarized light, while the second in-coupling device 500 located on the side of the waveguide 300 away from the first in-coupling device 400 may only diffract the second polarized light, but not the first polarized light. Therefore, the first polarized light and the second polarized light alternately generated by the image source 100 at the preset frequency may be coupled into the waveguide 300 by the first in-coupling device 400 and the second in-coupling device 500 respectively, and then the first sub-image and the second sub-image are respectively coupled out of the first polarized light and the second polarized light propagating in the waveguide 300 in the same preset area by the out-coupling device. Since the coupled-out first sub-image and the second sub-image are alternately displayed in human eyes, based on the persistence of human vision, the human eyes will automatically fuse and superimpose the first sub-image and the second sub-image into a total image. Therefore, the above waveguide display apparatus 10 realize the superposition and doubling of two different fields of view through the single waveguide 300. Compared with the traditional waveguide display apparatus with dual-waveguide, the thickness and weight of the waveguide display apparatus 10 are reduced. At the same time, because the first sub-image and the second sub-image have corresponding resolutions, the resolution of the fused total image is equal to the superposition of the resolutions of the first sub-image and the second sub-image. Therefore, the present solution can significantly increase the field of view and the resolution of the image on the premise of ensuring a compact structure of the waveguide display apparatus 10, and greatly improve the user experience.

The above is merely embodiments of the present disclosure. It should be appreciated that, those of ordinary skills in the art may make improvements without departing from the inventive concept of the present disclosure, such improvements, however, fall within the protection scope of the present disclosure.

What is claimed is:

1. A waveguide-based augmented reality display apparatus, comprising:
an image source, configured to display an image and generate a light beam according to image data of the displayed image, wherein the light beam comprises a first polarized light and a second polarized light alternately displayed at a preset frequency, the first polarized light has a first polarization state and the second polarized light has a second polarization state different from the first polarization state;
a single waveguide, being spaced from the image source;
a first in-coupling device, arranged on one side of the waveguide adjacent to the image source, and configured to couple the first polarized light into the waveguide;
a second in-coupling device, arranged on one side of the waveguide away from the first in-coupling device, and configured to couple the second polarized light into the waveguide;
a first out-coupling device, arranged on one side of the waveguide adjacent to the image source, and configured to couple out a first sub-image of the first polarized light propagating in the waveguide in a preset area; and
a second out-coupling device, arranged on one side of the waveguide away from the first out-coupling device, and configured to couple out a second sub-image of the second polarized light propagating in the waveguide in the same preset area;
wherein, an out-coupling grating vector of the first polarized light and an out-coupling grating vector of the second polarized light have different directions, and the first sub-image and the second sub-image are alternately displayed, and are fused and superimposed in human eyes due to a persistence of vision.

2. The waveguide-based augmented reality display apparatus according to claim 1, wherein the first in-coupling device and the first out-coupling device are transmission gratings.

3. The waveguide-based augmented reality display apparatus according to claim 2, wherein the second in-coupling device and the second out-coupling device are reflection gratings;
the second polarized light is coupled into the waveguide through the second in-coupling device, totally reflected in the waveguide and transmitted to the second out-coupling device, and then coupled out to the preset area through the second out-coupling device and the first out-coupling device sequentially.

4. The waveguide-based augmented reality display apparatus according to claim 1, wherein the first polarization state and the second polarization state are an S polarization state and a P polarization state, respectively.

5. The waveguide-based augmented reality display apparatus according to claim 1, wherein the first polarization state and the second polarization state are a left-handed circular polarization state and a right-handed circular polarization state, respectively.

6. The waveguide-based augmented reality display apparatus according to claim 1, wherein the image source comprises an image display for displaying the image and a polarization modulator arranged on one side of the image display adjacent to the waveguide, and the polarization modulator is configured to generate the first polarized light and the second polarized light displayed alternately based on the image data of the image.

7. The waveguide-based augmented reality display apparatus according to claim 1, wherein the first in-coupling device and the second in-coupling device are arranged on opposite sides of the waveguide and are aligned coaxially with an optical axis.

8. The waveguide-based augmented reality display apparatus according to claim 3, wherein the first out-coupling device and the second out-coupling device are arranged on opposite sides of the waveguide and are aligned coaxially with an optical axis.

9. The waveguide-based augmented reality display apparatus according to claim 1, wherein the image source is configured to alternately form the first polarized light and the second polarized light at a frequency greater than or equal to 48 frames per second, so that the display frequencies of the coupled-out first sub-image and the second sub-image are greater than or equal to 24 frames per second, respectively.

10. The waveguide-based augmented reality display apparatus according to claim 1, further comprising a collimator arranged between the image source and the waveguide, wherein the collimator is configured to process the first polarized light and the second polarized light into a collimated light.

11. The waveguide-based augmented reality display apparatus according to claim 1, wherein the first out-coupling device and the second out-coupling device have a grating vector of
$$\frac{\sqrt{2}}{2} {k}_{0} \sqrt{{n}_{1}^{2} + 1} ,$$
wherein k₀=2π/λₓ, and x=1 or 2; wherein λ₁ represents a wavelength of the first polarized light, λ₂ represents a wavelength of the second polarized light, and n₁ represents a refractive index of the waveguide;
wherein an out-coupling grating of the first out-coupling device and an out-coupling grating of the second out-coupling device have an angle of φ with a respective corresponding in-coupling grating, wherein φ=π/2-θ,
$$0 < θ \leq arcsin ( \frac{{n}_{1} - 1}{\sqrt{2} \sqrt{{n}_{1}^{2} + 1}} ) .$$
